(19) United States
(12) Patent Application Publication
(10) Pub. No.: US 2021/0149339 A1
(43) Pub. Date: May 20, 2021

(54) METHOD AND APPARATUS FOR SYNTHESIZING HIGH RESOLUTION COMPUTER GENERATED HOLOGRAM BASED ON MESH

(71) Applicant: Electronics and Telecommunications Research Institute, Daejeon (KR)

(72) Inventors: Han-Ju YEOM, Sejong-si (KR); Sanghoon CHEON, Daejeon (KR); Joongki PARK, Daejeon (KR); Kwan-Jung OH, Daejeon (KR); Keehoon HONG, Daejeon (KR)

(73) Assignee: Electronics and Telecommunications Research Institute, Daejeon (KR)

(21) Appl. No.: 16/950,481

(22) Filed: Nov. 17, 2020

(30) Foreign Application Priority Data
Nov. 19, 2019 (KR) 10-2019-0148882
Oct. 28, 2020 (KR) 10-2020-0140875

(51) Int. Cl. G03H 1/08; G03H 1/16; G03H 1/22

(52) U.S. Cl. CPC G03H 1/0891; G03H 1/2294; G03H 1/16

(57) ABSTRACT

An apparatus for synthesizing ultra-high resolution computer generated holograms based on mesh propagates a plurality of 3D meshes constituting the 3D model to a hologram plane, divides an entire angular spectrum area corresponding to a set maximum diffraction angle into a plurality of partial angular spectral areas, sequentially calculates and accumulates angular spectrums of the plurality of 3D meshes for each of the plurality of partial angular spectrum areas, and generates holograms for the 3D model from the angular spectrums accumulated for each of the plurality of partial angular spectrum areas.

### CROSS-REFERENCE TO RELATED APPLICATION

This application claims priority to and the benefit of Korean Patent Application Nos. 10-2019-0148882, and 10-2020-0140875 filed in the Korean Intellectual Property Office on Nov. 19, 2019, and Oct. 28, 2020, the entire contents of which are incorporated herein by reference.

### BACKGROUND OF THE INVENTION

### (a) Field of the Invention

The present invention relates to a method and apparatus for synthesizing an ultra-high resolution computer generated hologram based on mesh. More particularly, the present invention relates to a method and apparatus for synthesizing an ultra-high resolution computer generated hologram based on triangular mesh.

### (b) Description of the Related Art

Computer generated holograms are divided into point-cloud-based holograms and triangular mesh-based holograms according to the type of representation of a three-dimensional model.

The point-cloud-based hologram is generated by propagating spherical waves from points constituting a 3D model to a reference plane of the hologram, that is, a hologram plane, and accumulating and synthesizing spherical waves on the hologram plane. The point-cloud-based holograms can be calculated in a relatively simple way, but may be difficult to calculate a large area since a distance between points must be very narrow to represent a smooth surface.

The triangular mesh-based hologram is generated by propagating waveforms forming from triangular meshes constituting a 3D model to the hologram plane, and accumulating and synthesizing the waveforms on the hologram plane. The triangular mesh-based hologram has the advantage of being able to calculate a large area at once, unlike the point-cloud-based hologram. In addition, a triangular mesh-based method is commonly used in computer graphics (CG) where many technologies are organized, so it is easy to apply this technology to the triangular mesh-based hologram to generate a realistic 3D image.

A 3D image reproduced by a computer generated hologram has a limited viewing angle, different from a 2D image. In the computer generated hologram, the maximum diffraction angle is determined as in Equation 1 by the wavelength λ at which the hologram pattern is recorded and the pixel pitch p of the hologram, and has a viewing angle that is the same as the maximum diffraction angle.

$${θ}_{max} = {sin}^{- 1} \frac{λ}{2 p} \qquad ( Equation 1 )$$

As can be seen from Equation 1, the pixel pitch must be very narrow in order for the observer to observe a large area. However, by simply reducing the pixel pitch while maintaining the resolution, the size of the display is reduced and the image size of the 3D model is limited. Therefore, in order to implement a 3D model with a wide viewing angle and a large image size, an ultra-high resolution hologram with a narrow pixel pitch is required.

A large amount of memory is required to synthesize triangular mesh-based ultra-high resolution computer generated holograms. Even if an operation with a data size of single precision (4 bytes), which is half of double precision (8 bytes) is performed, the size of one matrix representing holograms of 100 K*100 K resolution is 74.5 GB [=100,000*100,000*4 bytes*2 (complex number)]. Furthermore, in order to synthesize triangular mesh-based holograms, calculations that require memory of at least twice of the size of the input matrix, such as fast Fourier transform (FFT), per mesh, are required. Thus, even if there is enough memory, it takes a very long time to calculate.

In order to synthesize ultra-high resolution computer generated holograms, a method was proposed in which the center of the 3D model is moved to the hologram plane, and the holograms are calculated by dividing the hologram plane and then the calculated holograms are propagated to a desired depth. This method removes the area where aliasing occurs using the maximum diffraction angle after propagating the triangular meshes to the hologram area to be calculated. However, this method is effective only when the size of the divided hologram area is larger than the wavefront area propagating from each mesh. When the maximum diffraction angle increases, the size of the triangular mesh is large, or the depth direction of the 3D model is large, and the hologram is recorded in a wider area than the size of the divided hologram area. Thus, 3D images that are repeated in an unintended direction are generated when the hologram is reproduced.

### SUMMARY OF THE INVENTION

The present invention has been made in an effort to provide a method and apparatus for synthesizing high resolution computer generated holograms based on mesh for improving synthesis speed of holograms regardless of a depth of the 3D model.

According to an embodiment of the present invention, a method for synthesizing ultra-high resolution computer generated holograms based on mesh that synthesizes holograms for a 3D (three-dimensional) model in a mesh-based ultra-high resolution computer generated hologram synthesis apparatus is provided. The method for synthesizing ultra-high resolution computer generated holograms based on mesh includes: propagating a plurality of 3D meshes constituting the 3D model to a hologram plane; dividing an entire angular spectrum area corresponding to a set maximum diffraction angle into a plurality of partial angular spectral areas; sequentially calculating and accumulating angular spectrums of the plurality of 3D meshes for each of the plurality of partial angular spectrum areas; and generating holograms for the 3D model from the angular spectrums accumulated for each of the plurality of partial angular spectrum areas.

The sequentially calculating and accumulating may include removing angular spectrums deviating from the hologram plane from angular spectrums of each 3D mesh using a band limitation parameter.

The sequentially calculating and accumulating may further include calculating the band limitation parameter based on the coordinates of the corresponding 3D mesh and the position of the hologram plane.

The sequentially calculating and accumulating may include: sequentially calculating angular spectrums of a plurality of 3D meshes; removing the angular spectrum deviating from the hologram plane in the calculated angular spectrum of each 3D mesh by setting a band limit; and accumulating the angular spectrum of the each 3D mesh.

The sequentially calculating may include: rotating each 3D mesh into a 2D mesh; calculating angular spectrums of the 2D mesh by performing a 2D fast Fourier transform of the 2D mesh; and calculating the angular spectrums of a corresponding 3D mesh using the angular spectrums of the 2D mesh.

The generating may include calculating the holograms by performing a fast Fourier transform on the angular spectrums accumulated for each of the plurality of partial angular spectrum areas.

The mesh may include a triangular mesh.

According to another exemplary embodiment of the present invention, an apparatus for synthesizing ultra-high resolution computer generated holograms based on mesh that synthesizes holograms for a 3D (three-dimensional) model is provided. The apparatus for synthesizing ultra-high resolution computer generated holograms based on mesh includes a mesh generator, an angular spectrum divider, an angular spectrum calculator, and a hologram generator. The mesh generator generates a plurality of 3D meshes constituting a 3D model, and propagates the plurality of 3D meshes to a hologram plane. The angular spectrum divider that divides the entire angular spectrum area set based on a maximum diffraction angle into a plurality of partial angular spectrum areas. The angular spectrum calculator sequentially calculates angular spectrums of the plurality of 3D meshes with respect to the hologram plane for each partial angular spectrum area and accumulates the calculated angular spectrums. The hologram generator generates holograms from the angular spectrums of the plurality of partial angular spectrum areas.

The angular spectrum calculator limits angular spectrums of the each 3D mesh that deviates from the hologram plane.

The angular spectrum calculator calculates a band limiting parameter based on coordinates of a corresponding 3D mesh and a position of the hologram plane, and removes angular spectrums that deviate from the hologram plane in the angular spectrums of the corresponding 3D mesh using the band limitation parameter.

The angular spectrum calculator maps a 3D mesh to a 2D mesh, calculates angular spectrums of the 2D mesh by performing a 2D fast Fourier transform, and calculates angular spectrums of the 3D mesh using the angular spectrums of the 2D mesh.

The hologram generator calculates the holograms by performing fast Fourier transform on the angular spectrums accumulated for each of the plurality of partial angular spectrum areas.

### BRIEF DESCRIPTION OF THE DRAWINGS

FIG. 1 is a diagram illustrating a conventional ultra-high resolution computer generated hologram method.

FIG. 2 is a diagram illustrating an example of a hologram generated in a hologram area from the method illustrated in FIG. 1.

FIG. 3 is a diagram illustrating an example of a hologram generated in a hologram area when a wavefront area propagating from a triangular mesh exceeds a divided hologram area in the method shown in FIG. 1.

FIG. 4 is a diagram illustrating a repetitive image displayed when a hologram is reproduced in the case of FIG. 3.

FIG. 5 is a diagram illustrating a relationship between an angular spectrum and a hologram in a computer generated hologram to which an embodiment of the present invention is applied.

FIG. 6 is a diagram illustrating division of an angular spectrum according to an embodiment of the present invention.

FIG. 7 is a diagram illustrating the relationship between the propagation angle on the hologram plane and the angular spectrum when an angular spectrum is generated in units of divided partial angular spectrum areas.

FIG. 8 is a diagram illustrating an example of an angular spectrum and a hologram generated when the divided hologram area in the conventional method is larger than the wavefront of the incident triangular mesh, but only one side of the wavefront deviates from the hologram area.

FIG. 9 is a diagram illustrating an example of an angular spectrum and a hologram generated from an ultra-high resolution computer generated hologram method according to an embodiment of the present invention.

FIG. 10 is a diagram illustrating another example of an angular spectrum and a hologram generated when a divided hologram area is smaller than a wavefront of an incident triangular mesh in the method.

FIG. 11 is a diagram illustrating another example of an angular spectrum and a hologram generated from an ultra-high resolution computer generated hologram method according to an embodiment of the present invention.

FIG. 12 is a diagram illustrating a method for synthesizing ultra-high resolution computer generated holograms based on mesh according to an embodiment of the present invention.

FIG. 13 is a diagram illustrating an apparatus for synthesizing ultra-high resolution computer generated holograms based on mesh according to an embodiment of the present invention.

FIG. 14 is a diagram illustrating an apparatus for synthesizing ultra-high resolution computer generated holograms based on mesh according to another embodiment of the present invention.

### DETAILED DESCRIPTION OF THE EMBODIMENTS

Hereinafter, embodiments of the present invention will be described in detail with reference to the attached drawings so that a person of ordinary skill in the art may easily implement the present invention. The present invention may be modified in various ways, and is not limited thereto. In the drawings, elements that are irrelevant to the description of the present invention are omitted for clarity of explanation, and like reference numerals designate like elements throughout the specification.

Throughout the specification and claims, when a part is referred to “include” a certain element, it means that it may further include other elements rather than exclude other elements, unless specifically indicated otherwise.

Hereinafter, a method and apparatus for synthesizing ultra-high resolution computer generated holograms (CGH) based on mesh according to embodiments of the present invention will be described in detail with reference to the accompanying drawings.

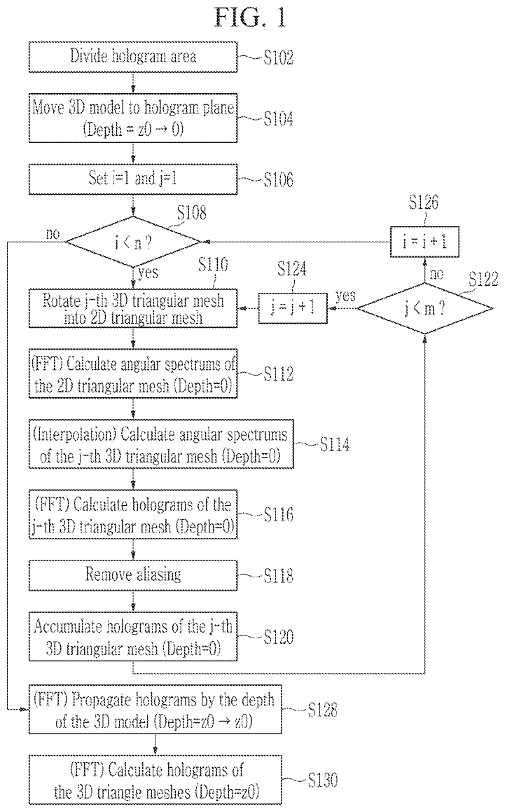

FIG. 1 is a diagram illustrating a conventional ultra-high resolution CGH method.

Referring to FIG. 1, the conventional ultra-high resolution CGH synthesis apparatus divides a hologram plane into a plurality of small hologram areas, moves the center of the 3D (three-dimensional) model to the hologram plane (depth=z0=0), and calculates holograms in each hologram area. Then, the conventional ultra-high resolution CGH synthesis apparatus propagates the calculated holograms to the desired depth (depth=z0). Here, z0 represents the distance between the original position of the 3D model and the hologram plane, which is expressed as depth.

Specifically, the conventional ultra-high resolution CGH synthesis apparatus divides the hologram plane into (n−1) hologram areas (S102).

The conventional ultra-high resolution CGH synthesis apparatus moves the 3D model to the hologram plane (depth=z0=0) (S104), and then propagates the 3D triangular meshes constituting the 3D model to the hologram area to be calculated. The conventional ultra-high resolution CGH synthesis apparatus sequentially accesses (n−1) hologram areas to generate holograms in each hologram area.

The conventional ultra-high resolution CGH synthesis apparatus is set to i=1 and j=1 (S106). i is an index indicating a hologram area, and j is an index indicating a triangular mesh.

The conventional ultra-high resolution CGH synthesis apparatus checks whether i is less than n in order to generate a hologram for the j-th 3D triangular mesh in the i-th hologram area (S108). If i is less than n, it means that there is still a hologram area to be calculated, and if i is equal to n, it means that holograms of the 3D triangular meshes in (n−1) hologram areas have been calculated at z0=0.

When i is less than n, the conventional ultra-high resolution CGH synthesis apparatus performs a process of generating holograms of 3D triangular meshes in the i-th hologram area. Specifically, the conventional ultra-high resolution CGH synthesis apparatus rotates the j-th 3D triangular mesh into a 2D (two-dimensional) triangular mesh (S110), and calculates an angular spectrum of the 2D triangular mesh (S112). The hologram and the angular spectrum have a relationship of a 2D Fast Fourier Transform (FFT). The angular spectrum of the 2D triangular mesh can be calculated by the FFT of the 2D triangular mesh. Input data in triangular mesh-based CGH are coordinates in 3D space. Assuming that the 3D model consists of one triangle, since the triangle is represented by 3 points, the input data for the 3D triangle mesh is coordinate values of (x, y, z) corresponding to each of the three points. As an example, input data for a 3D triangular mesh may include (0, 0, 0.5), (0, 1, 0.3), and (1, 1, 0.8). Such 3D triangular mesh can be mapped to the 2D triangular mesh through rotation. By converting the z-coordinate values of the (x, y, z) coordinate values corresponding to the three points to 0 or all the same values, the 3D triangular mesh can be mapped to the 2D triangular mesh. For example, the 3D triangular mesh corresponding to [(0, 0, 0.5), (0, 1, 0.3), (1, 1, 0.8)] can be mapped to the 2D triangular mesh corresponding to [(0, 0, 0), (0, 1, 0), (1, 1, 0)]. That is, the 2D triangular mesh may be a 2D matrix in which values inside of the triangle are 1 and the rest are 0. The 2D matrix of the triangle is a hologram on a triangular plane. Therefore, when a 2D FFT is performed with a 2D matrix, the angular spectrum of the 2D triangular mesh can be calculated.

The conventional ultra-high resolution CGH synthesis apparatus calculates the angular spectrum of the 3D triangular mesh using the angular spectrum of the 2D triangular mesh (S114). The conventional ultra-high resolution CGH synthesis apparatus may obtain the angular spectrum of the 3D triangular mesh by modifying the angular spectrum of the 2D triangular mesh using the rotation angle in step S110. This process corresponds to an operation similar to interpolation.

The conventional ultra-high resolution CGH synthesis apparatus calculates the hologram of the j-th 3D triangular mesh by using the angular spectrum of the j-th 3D triangular mesh (S116). The hologram can be obtained by performing a 2D IFFT on the angular spectrum of the j-th 3D triangular mesh.

The conventional ultra-high resolution CGH synthesis apparatus removes the area where aliasing occurs using the maximum diffraction angle (S118), and accumulates the hologram of the j-th 3D triangular mesh (S120).

The conventional ultra-high resolution CGH synthesis apparatus checks whether j is less than m (S122). When j is less than m, it indicates that there is still a 3D triangular mesh to be calculated in the corresponding hologram area, and when j=m, it indicates that all holograms for the 3D triangular meshes have been calculated in the corresponding hologram area. Here, m may represent the number of triangular meshes constituting the 3D model. The m can be determined by Equation 1 and the coordinates of the triangular meshes. Generally, the calculation is performed on m triangular meshes. However, since the hologram areas are at the center of the 3D model, not all holograms of m triangular meshes are recorded in each hologram area. Accordingly, the conventional ultra-high resolution CGH synthesis apparatus checks whether j is less than m in the corresponding hologram area, and then checks whether the hologram of the corresponding j-th triangular mesh is recorded in the corresponding hologram area.

If j is less than m, the conventional ultra-high resolution CGH synthesis apparatus sets j to (j+1) (S124), and repeats steps (S110 to S120) to calculate and accumulate the hologram of another 3D triangular mesh propagated to the i-th hologram area.

The conventional ultra-high resolution CGH synthesis apparatus repeats steps (S110 to S124) to accumulate holograms of all 3D triangular meshes propagated to the i-th hologram area, and then sets i to (i+1) (S126), and repeats steps (S108 to S124) to accumulate holograms of all 3D triangular meshes propagated to another hologram area. In this way, the conventional ultra-high resolution CGH synthesis apparatus generates holograms of 3D triangular meshes in all (n−1) hologram areas.

After the holograms of the 3D triangular meshes are calculated in all (n−1) hologram areas, the conventional ultra-high resolution CGH synthesis apparatus propagates the holograms of the 3D model obtained on the hologram plane by the depth of the 3D model (depth=z0) (S128), and calculates the hologram of the 3D model (S130). In step S128, the angular spectrums at the corresponding depth (depth=0) is calculated by performing 2D IFFT on the calculated holograms of the 3D model. The angular spectrums at the position moved by the depth (depth=z0) is calculated by performing an additional operation that considers the depth on the calculated angular spectrums. Then, holograms of the 3D model at the position moved by the depth (depth=z0), that is, at the original location, are generated by performing the 2D IFFT on the angular spectrums at the position moved by the depth (depth=z0).

The conventional ultra-high resolution CGH synthesis method described in FIG. 1 is effective only when the size of the divided hologram area is larger than the wavefront area propagated from the 3D triangular mesh, and needs the step (S104) of moving the 3D model to the hologram plane (S104). That is, when the maximum diffraction angle increases, the size of the triangular mesh is large or the depth of the 3D model is deep, the hologram may be recorded in a larger area than the size of the divided hologram area.

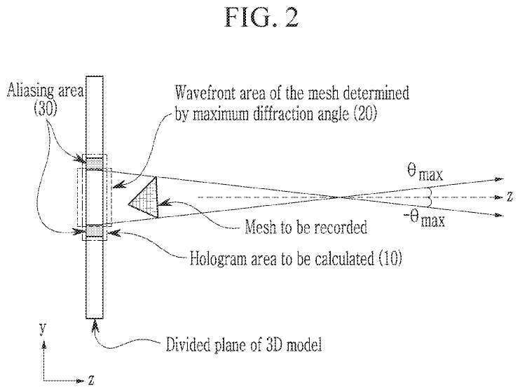

FIG. 2 is a diagram illustrating an example of a hologram generated in a hologram area from the method illustrated in FIG. 1, and shows a case where the divided hologram area 10 is larger than the wavefront area 20 propagating from a triangular mesh.

Referring to FIG. 2, a triangular mesh is propagated to the hologram area to be calculated, and a hologram for the triangular mesh is generated. At this time, the wavefront area 20 of the triangular mesh is determined in the hologram area 10 using the maximum diffraction angle θₘₐₓ, and an aliasing area 30 except the wavefront area 20 is removed from the hologram area 10.

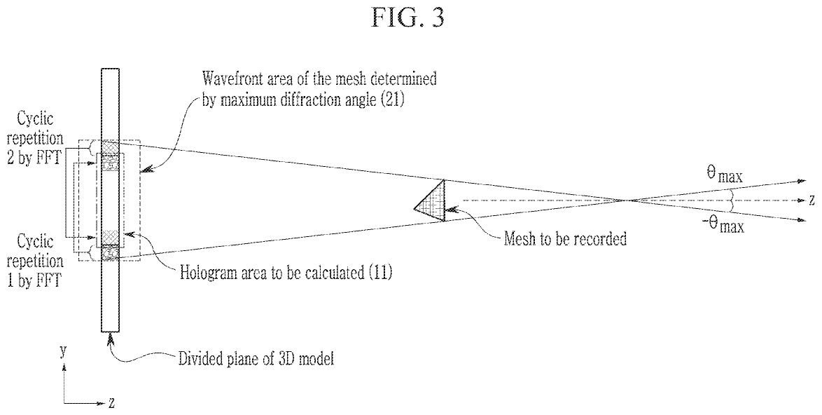

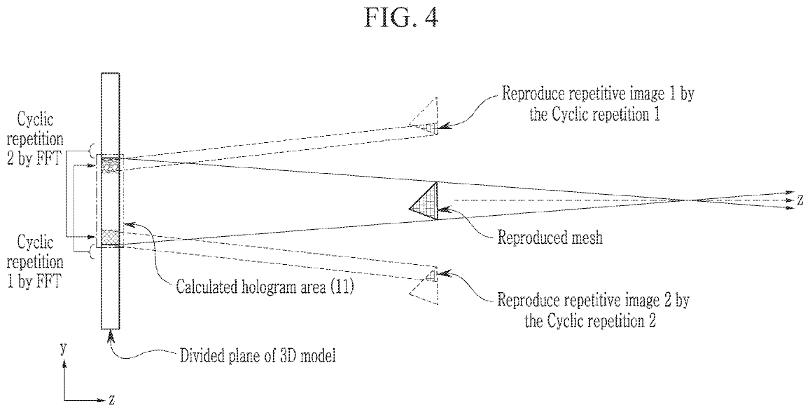

FIG. 3 is a diagram illustrating an example of a hologram generated in a hologram area when a wavefront area propagating from a triangular mesh exceeds a divided hologram area in the method shown in FIG. 1, and FIG. 4 is a diagram illustrating a repetitive image displayed when a hologram is reproduced in the case of FIG. 3.

As shown in FIG. 3, the wavefront area 21 propagating from the triangular mesh may exceed the divided hologram area 11. The hologram patterns exceeding the size of the hologram area 11 are not removed, and cyclic repetition occurs by the hologram calculation step (S116 of FIG. 1) of the 3D triangular mesh using FFT. Accordingly, hologram patterns are recorded in an adjacent hologram area, and images that are repeated in an unintended direction are shown as in FIG. 4 when the holograms are reproduced.

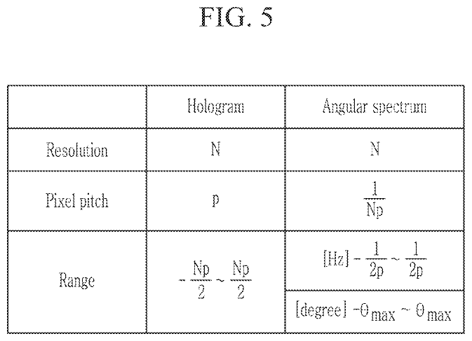

FIG. 5 is a diagram illustrating a relationship between an angular spectrum and a hologram in a computer generated hologram to which an embodiment of the present invention is applied.

A hologram in CGH, has an FFT relationship with an angular spectrum, and has a relationship as shown in FIG. 5 with the variables of the angular spectrum. FIG. 5 is a representation of one dimension, and the angular spectrum may be expressed as a propagation angle (degree) of light. Therefore, in the case of a 2D hologram, the range of the angular spectrum can be expressed as (Ox, By) in the left-right direction and the up-down direction.

In an embodiment of the present invention, the ultra-high resolution hologram is generated by dividing the angular spectrum representing the propagation angle of light based on the relationship between the angular spectrum and the hologram.

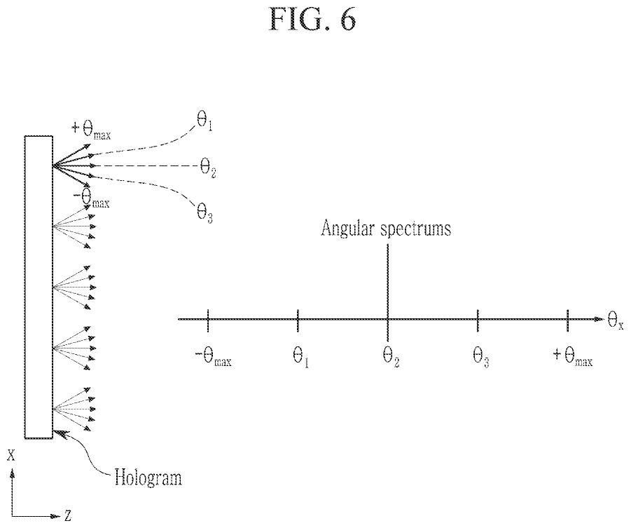

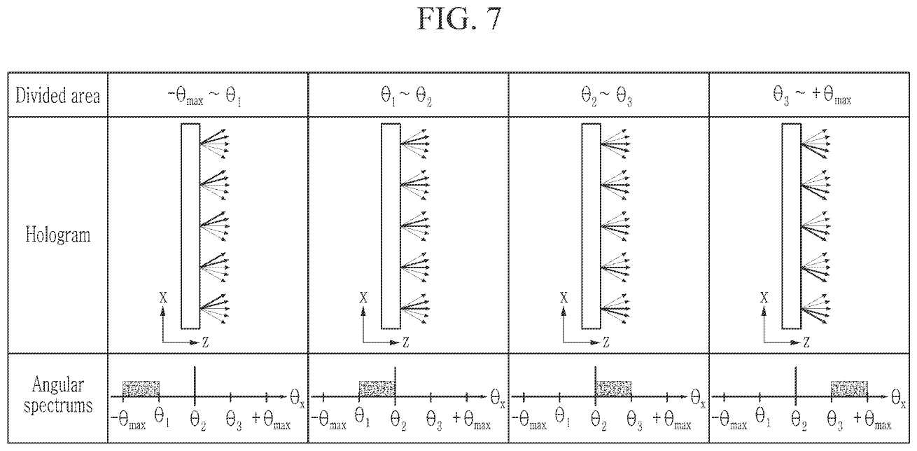

FIG. 6 is a diagram illustrating division of the angular spectrum according to an embodiment of the present invention, and FIG. 7 is a diagram illustrating the relationship between the propagation angle on the hologram plane and the angular spectrum when an angular spectrum is generated in units of divided partial angular spectrum areas.

Referring to FIG. 6, the entire angular spectrum area is divided into a plurality of partial angular spectrum areas. For example, the angular spectrum corresponding to between −θₘₐₓ and θₘₐₓ may be divided into four partial angular spectrum areas of −θₘₐₓ to θ₁, θ₁ to θ₂, θ₂ to θ₃, and θ₃ to θₘₐₓ.

In addition, referring to FIG. 7, when the angular spectrum of the divided partial angular spectrum area is calculated, a hologram propagating in the direction of the angular spectrum within the divided partial angular spectrum area is calculated. Here, the partial angular spectrum area is a concept corresponding to the hologram observation direction of the observer, and if the angular spectrum of the divided partial angular spectrum area is calculated, it means that the hologram is reproduced when observed in the corresponding angular spectrum direction. For example, when angular spectrum of a partial angular spectrum area corresponding to θ₂ to θ₃ is calculated, a hologram propagating in the direction from θ₂ to θ₃ is calculated.

As shown in FIGS. 3 and 4, the conventional ultra-high resolution CGH synthesis method described based on FIG. 1, when the wavefront propagating from the triangular mesh reaches the hologram plane, if the wavefront of the incident triangular mesh is larger than the hologram area in which the hologram is to be recorded, the repetitive pattern occurs due to cyclic repetition. This repetition pattern is generated in the process of FFT of the angular spectrum to remove the aliasing area in the hologram region area. Therefore, when a condition in which the wavefront of the incident triangular mesh is larger than the hologram area in which the hologram is to be recorded occurs, the repetitive pattern occurs. For example, when the size of the hologram area to be calculated is small, the size of the triangle mesh is increased or the depth of the triangle mesh is increased, the wavefront area of the incident triangular mesh may be larger than the hologram area.

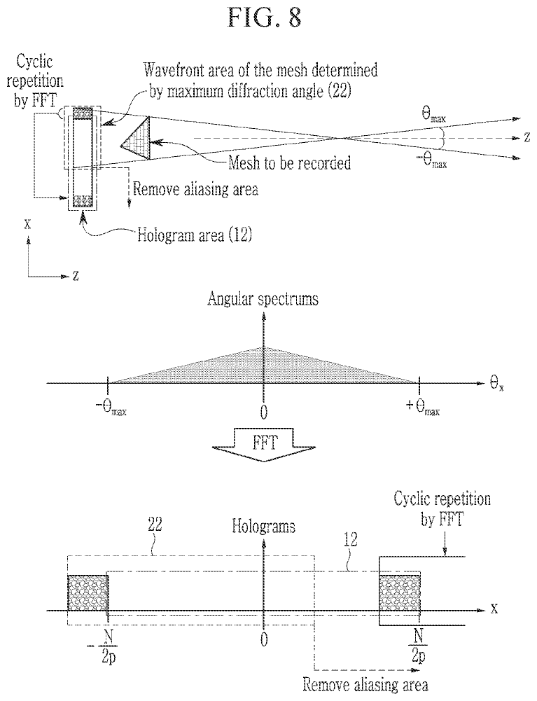

FIG. 8 is a diagram illustrating an example of an angular spectrum and a hologram generated when the divided hologram area in the conventional method is larger than the wavefront of the incident triangular mesh, but only one side of the wavefront deviates from the hologram area.

Referring to FIG. 8, when the hologram area 12 is larger than the wavefront area 22 of the incident triangular mesh, but only one side of the wavefront area 22 of the incident triangular mesh deviates from the hologram area 12, the angular spectrum of the triangular mesh is not limited to the direction of the wavefront propagating from the triangular mesh, and angular spectral values exist in all angular spectrum area from −θₘₐₓ to θₘₐₓ. However, a hologram pattern that should not be recorded in the aliasing area due to cyclic repetition by performing FFT of the angular spectrum is recorded. When the hologram is reproduced by the hologram pattern recorded in this way, an unintended image as shown in FIG. 4 occurs. Therefore, in the conventional CGH synthesis method, this problem can be solved by removing the aliasing area in the hologram pattern.

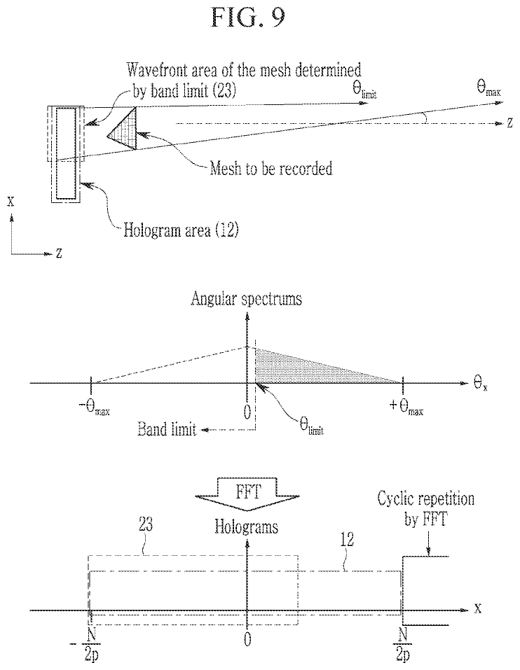

FIG. 9 is a diagram illustrating an example of an angular spectrum and a hologram generated from an ultra-high resolution computer generated hologram method according to an embodiment of the present invention.

Referring to FIG. 9, in the method for synthesizing ultra-high resolution CGH, a band limit parameter θₗᵢₘᵢₜ is used to limit the wavefront area of the triangular mesh outside the hologram area 12 as shown in FIG. 8. That is, the wavefront area 23 of the triangular mesh incident by the band limit parameter θₗᵢₘᵢₜ is limited as shown in FIG. 9 and does not deviate from the hologram area 12. The band limit parameter θₗᵢₘᵢₜ may be calculated in consideration of the coordinates of the triangular mesh and the position of the hologram area 12. In this way, angular spectral values do not exist in all angular spectrum areas from −θₘₐₓ to θₘₐₓ, and angular spectral values exist only in angular spectral regions from −θₘₐₓ to θₗᵢₘᵢₜ. That is, the angular spectrum is limited by the band limit parameter θₗᵢₘᵢₜ. When the angular spectrum calculated in this way is converted into a hologram by performing FFT, the cyclic repetition patterns by performing FFT may occur in the hologram area 12.

As described above, in the method for synthesizing the ultra-high resolution CGH according to an embodiment of the present invention, when the wavefront area of the triangular mesh exceeds the hologram area, the angular spectrum area is limited by applying the band limit parameter θₗᵢₘᵢₜ, and the repetitive patterns can be removed without performing FFT compared to the conventional method.

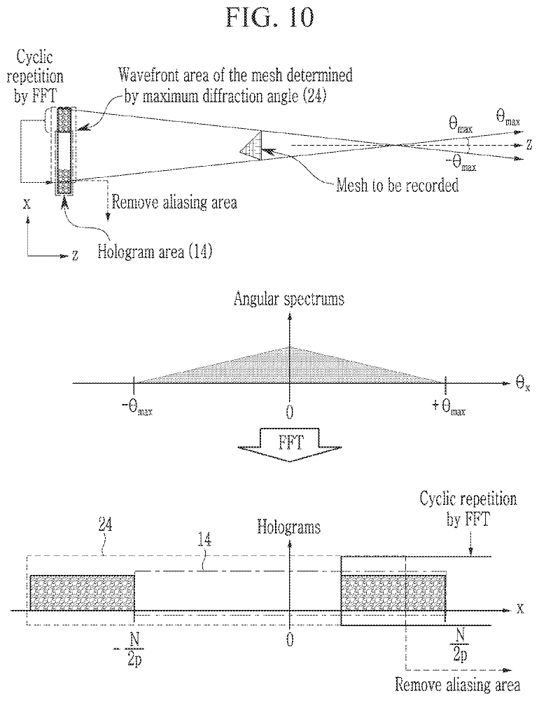

FIG. 10 is a diagram illustrating another example of an angular spectrum and a hologram generated when a divided hologram area is smaller than a wavefront of an incident triangular mesh in the method.

Referring to FIG. 10, even when the hologram area 14 is smaller than the wavefront area 24 of the incident triangular mesh, the angular spectrum values exist in the entire angular spectrum area from −θₘₐₓ to θₘₐₓ. However, unlike FIG. 8 in which the cyclic repetition by performing the FFT occurs within the aliasing area, the cyclic repetition occurs until an area other than the aliasing area by the wavefront area 24 of the expanded triangular mesh. In this case, the repeated hologram pattern cannot be removed even by removing the aliasing area. Accordingly, as shown in FIG. 4, a problem occurs in that an image is reproduced in an unintended direction.

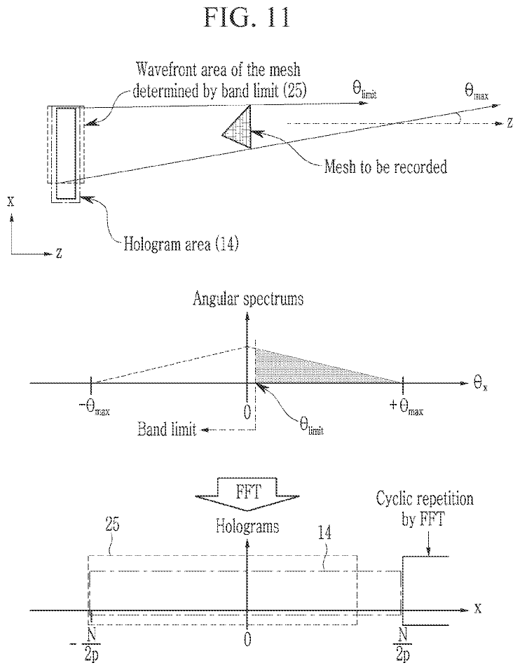

FIG. 11 is a diagram illustrating another example of an angular spectrum and a hologram generated from an ultra-high resolution computer generated hologram method according to an embodiment of the present invention.

Referring to FIG. 11, in the method for synthesizing an ultra-high resolution CGH according to the embodiment of the present invention, when the hologram area 14 is smaller than the wavefront area of the incident triangular mesh, as shown in FIG. 10, the band limit parameter θₗᵢₘᵢₜ is used to limit the wavefront area of the triangular mesh deviate from the hologram area 14. That is, the wavefront area 25 of the incident triangular mesh by the band limit parameter θₗᵢₘᵢₜ is limited as shown in FIG. 11 and does not deviate from the hologram area 14.

In this way, angular spectrum values exist only in the angular spectrum area from −θₘₐₓ to θₗᵢₘᵢₜ, and when the angular spectrum is converted into a hologram by performing FFT, a cyclic repetition pattern is not recorded in the hologram area 14.

Also, referring to FIG. 11, unlike FIG. 9, it can be seen that as the depth of the triangle mesh to be recorded increases, the wavefront area of the triangle mesh increases. The depth of the triangle mesh can be found from the coordinates of the triangle mesh.

In this way, even if the depth of the triangular mesh is increased, if the band limiting parameter is used, the wavefront of the triangular mesh can be limited to exist only within the hologram area 14 to be calculated.

As described above, in the embodiment of the present invention, by using the band limit parameter that limits the propagation angle of light in angular spectrum area, the repetitive pattern may be removed without converting each spectrum into a hologram.

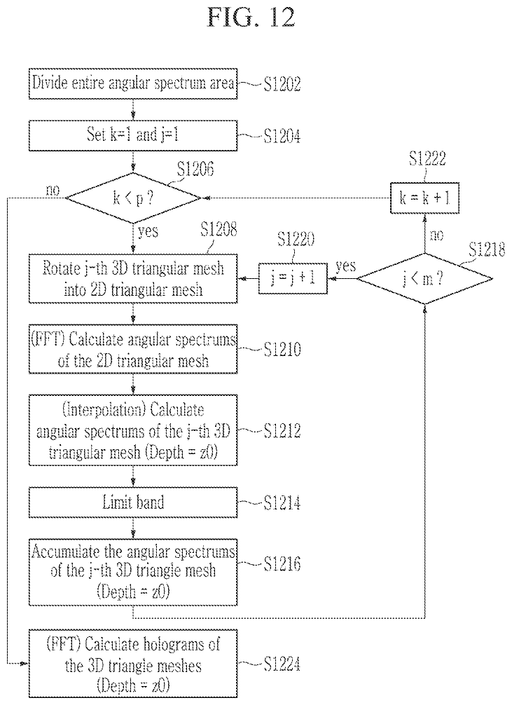

FIG. 12 is a diagram illustrating a method for synthesizing ultra-high resolution computer generated holograms based on mesh according to an embodiment of the present invention.

Referring to FIG. 12, the apparatus for synthesizing ultra-high resolution CGH based on the mesh according to an embodiment of the present invention reduces the memory load of the ultra-high resolution CGH by dividing the angular spectrum area instead of dividing the hologram plane as shown in FIG. 1.

The apparatus propagates the 3D triangular meshes constituting the 3D model to the hologram plane. The conventional ultra-high resolution CGH synthesis method shown in FIG. 1 requires a process of moving a 3D model to a holographic plane, but this process is not required in the method according to an embodiment of the present invention.

The apparatus divides the entire angular spectrum area corresponding to the set maximum diffraction angle into (p−1) partial angular spectrum areas (S1202).

The apparatus sequentially accesses the divided (p−1) partial angular spectrum areas, calculates the angular spectrum of all the triangular meshes constituting the 3D model, and accumulates the calculated angular spectrum.

Specifically, the apparatus is set to k=1 and j=1 (S1204). k is an index indicating a partial angular spectrum area.

The apparatus checks whether k is less than p in order to generate a hologram for the j-th 3D triangular mesh in the k-th partial angular spectrum area (S1206). If k is less than p, it means that there is still a partial angular spectrum area to be calculated, and if k is equal to p, it means that all the angular spectrums of the 3D triangular meshes have been calculated for (p−1) partial angular spectrum areas.

When k is less than p, the apparatus performs the process of calculating the spectrum of the 3D triangular mesh in the k-th partial angular spectrum area. For this process, the apparatus rotates the j-th 3D triangular mesh into a 2D triangular mesh (S1208), and calculates angular spectrums of the 2D triangular mesh (S1210). The apparatus calculates the angular spectrums of the j-th 3D triangular mesh using the angular spectrum of the 2D triangular mesh (S1212).

Next, the apparatus limits the angular spectrum of the j-th 3D triangle mesh using a band limiting parameter to limit the propagation angle of light to deviate from the hologram plane (S1214), and accumulates the angular spectrums of the j-th 3D triangle mesh (S1216). Since the apparatus does not divide the hologram plane, it calculates the band limiting parameter based on the entire hologram plane, and may calculate the band limiting parameter in consideration of the coordinates of the triangular mesh and the entire hologram plane.

If j is less than m (S1218), the apparatus sets j to (j+1) (S1220), and repeats steps (S1208 to S1216) to calculate and accumulate the angular spectrum of another 3D triangular mesh propagated to the k-th partial angular spectrum area.

The apparatus repeats steps (S1208 to S1220) to accumulate the angular spectrums of all 3D triangular meshes propagated to the hologram plane in the k-th partial angular spectrum area, and then sets k to (k 1) (S1222), and repeats steps (S1208 to S1222) to accumulate the angular spectrums of all 3D triangular meshes propagated to the hologram plane in the partial angular spectrum area. In this way, the apparatus calculates the angular spectrums of all 3D triangular meshes propagated to the hologram plane in all (p−1) partial angular spectrum areas.

The angular spectrums of the 3D triangular meshes by repeating the steps described above for all partial angular spectrum areas to be calculated, and the apparatus calculates the holograms by performing FFT on the angular spectrums calculated for all angular spectrum areas (S1224).

In this way, the ultra-high resolution CGH synthesis for the 3D model is ended.

In the conventional ultra-high resolution CGH synthesis method, as described in FIG. 1, the 3D model is moved to the hologram plane to calculate the angular spectrums of the 3D triangular meshes. As described above, this is a method of reducing the hologram area of the triangular meshes incident on the hologram plane in order to remove the cyclic repetition due to performing FFT while removing the aliasing area. But an additional step of propagating the hologram by the depth of the 3D model due to moving the 3D model to the hologram plane is needed.

However, in the method for synthesizing ultra-high resolution CGH based on the mesh according to an embodiment of the present invention, since there is no limit to the size of the wavefront of the incident triangular meshes, the angular spectrums of the 3D triangular meshes may be calculated while maintaining the depth of the 3D model. Accordingly, not only may the conventional triangular mesh-based ultra-high resolution CGH synthesis process be simplified, but also the FFT to be performed per triangular mesh can be reduced. So the computation time may be reduced.

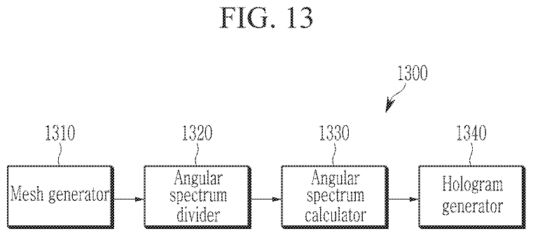

FIG. 13 is a diagram illustrating an apparatus for synthesizing ultra-high resolution computer generated hologram based on mesh according to an embodiment of the present invention.

Referring to FIG. 13, an apparatus for synthesizing an ultra-high resolution CGH based on mesh 1300 includes a mesh generator 1310, an angular spectrum divider 1320, an angular spectrum calculator 1330, and a hologram generator 1340.

The mesh generator 1310 generates 3D triangular mesh data constituting a 3D model (object). The mesh generator 1310 propagates the 3D triangular mesh data to the hologram plane.

The angular spectrum divider 1320 divides the entire angular spectrum area into a plurality of partial angular spectrum areas based on the maximum diffraction angle of CGH.

The angular spectrum calculator 1330 sequentially calculates angular spectrums of 3D triangular mesh data constituting a 3D model (object) in the plurality of partial angular spectral areas, and accumulates the calculated angular spectrum. The angular spectrum calculator 1330 may limit the angular spectrum of the 3D triangular mesh data using a band limit parameter after calculating an angular spectrum of the 3D triangular mesh data. The angular spectrum calculator 1330 may calculate a band limit parameter value in consideration of the coordinates of the triangular mesh data and the position of the entire hologram plane.

The hologram generator 1340 generates holograms by performing FFT angular spectrums of a plurality of partial angular spectrum areas calculated by the angular spectrum calculator 1330.

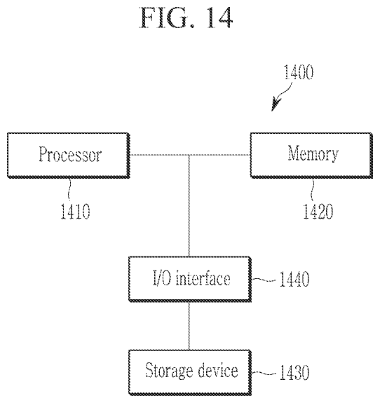

FIG. 14 is a diagram illustrating an apparatus for synthesizing ultra-high resolution computer generated hologram based on mesh according to another embodiment of the present invention.

Referring to FIG. 14, an apparatus for synthesizing ultra-high resolution computer generated hologram based on mesh 1400 includes a processor 1410, a memory 1420, a storage device 1430, and an input/output (I/O) interface 1440.

The processor 1410 may be implemented as a central processing unit (CPU) or other chipset, a microprocessor, etc.

The memory 1420 may be implemented as a medium such as random access memory (RAM), dynamic random access memory (DRAM), rambus DRAM (RDRAM), synchronous DRAM (SDRAM), static RAM (SRAM), etc.

The storage device 1430 may be implemented as a hard disk, optical disks such as a compact disk read only memory (CD-ROM), a CD rewritable (CD-RW), a digital video disk ROM (DVD-ROM), a DVD-RAM, a DVD-RW disk, Blu-ray disks, etc., a flash memory, or permanent or volatile storage devices such as various types of RAM.

The I/O interface 1440 allows the processor 1410 and/or the memory 1420 to access the storage device 1430.

The processor 1410 may perform a function for synthesizing ultra-high resolution CGH based on the triangular mesh described with reference to FIGS. 9, 11, 12, and 13, and may load a program command for implementing at least some function of the mesh generator 1310, the angular spectrum divider 1320, the angular spectrum calculator 1330, and the hologram generator 1340 in the memory 1420, and may control to perform the operation described with reference to FIGS. 9, 11, 12, and 13. These program commands may be stored in the storage device 1430, or may be stored in another system connected through a network.

According to an embodiment of the present invention, the aliasing and cyclic repetition due to the FFT operation in the angular spectral area other than the hologram area may be removed regardless of the depth of the 3D model. Therefore, it is possible to reduce one FFT operation per mesh and to omit the propagation process from the center of the 3D model to the hologram plane, so it is possible to generate ultra-high resolution holograms at a faster speed than the conventional triangular mesh-based hologram synthesis method.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (08) and one or more software applications that run on the OS. The processor device also may access, store, manipulate, process, and create data in response to execution of the software. For purpose of simplicity, the description of a processor device is used as singular however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method for synthesizing ultra-high resolution computer generated holograms based on mesh that synthesizes holograms for a 3D (three-dimensional) model in a mesh-based ultra-high resolution computer generated hologram synthesis apparatus, the method comprising:
propagating a plurality of 3D meshes constituting the 3D model to a hologram plane;
dividing an entire angular spectrum area corresponding to a set maximum diffraction angle into a plurality of partial angular spectral areas;
sequentially calculating and accumulating angular spectrums of the plurality of 3D meshes for each of the plurality of partial angular spectrum areas; and
generating holograms for the 3D model from the angular spectrums accumulated for each of the plurality of partial angular spectrum areas.

2. The method of claim 1, wherein the sequentially calculating and accumulating includes removing angular spectrums deviating from the hologram plane from angular spectrums of each 3D mesh using a band limitation parameter.

3. The method of claim 2, wherein the sequentially calculating and accumulating further includes calculating the band limitation parameter based on the coordinates of the corresponding 3D mesh and the position of the hologram plane.

4. The method of claim 1, wherein the sequentially calculating and accumulating further includes:
sequentially calculating angular spectrums of a plurality of 3D meshes;
removing the angular spectrum deviating from the hologram plane in the calculated angular spectrum of each 3D mesh by setting a band limit; and
accumulating the angular spectrum of the each 3D mesh.

5. The method of claim 4, wherein the sequentially calculating includes:
rotating each 3D mesh into a 2D mesh;
calculating angular spectrums of the 2D mesh by performing a 2D fast Fourier transform of the 2D mesh; and
calculating the angular spectrums of a corresponding 3D mesh using the angular spectrums of the 2D mesh.

6. The method of claim 1, wherein the generating includes calculating the holograms by performing a fast Fourier transform on the angular spectrums accumulated for each of the plurality of partial angular spectrum areas.

7. The method of claim 1, wherein the mesh includes a triangular mesh.

8. An apparatus for synthesizing ultra-high resolution computer generated holograms based on mesh that synthesizes holograms for a 3D (three-dimensional) model, the apparatus comprising:
a mesh generator that generates a plurality of 3D meshes constituting a 3D model and propagates the plurality of 3D meshes to a hologram plane;
an angular spectrum divider that divides the entire angular spectrum area set based on a maximum diffraction angle into a plurality of partial angular spectrum areas;
an angular spectrum calculator that sequentially calculates angular spectrums of the plurality of 3D meshes with respect to the hologram plane for each partial angular spectrum area and accumulates the calculated angular spectrums; and
a hologram generator that generates holograms from the angular spectrums of the plurality of partial angular spectrum areas.

9. The apparatus of claim 8, wherein the angular spectrum calculator limits angular spectrums of each 3D mesh that deviates from the hologram plane.

10. The apparatus of claim 9, wherein the angular spectrum calculator calculates a band limiting parameter based on coordinates of a corresponding 3D mesh and a position of the hologram plane, and removes angular spectrums that deviate from the hologram plane in the angular spectrums of the corresponding 3D mesh using the band limitation parameter.

11. The apparatus of claim 8, wherein the angular spectrum calculator maps a 3D mesh to a 2D mesh, calculates angular spectrums of the 2D mesh by performing a 2D fast Fourier transform, and calculates angular spectrums of the 3D mesh using the angular spectrums of the 2D mesh.

12. The apparatus of claim 8, wherein the hologram generator calculates the holograms by performing fast Fourier transform on the angular spectrums accumulated for each of the plurality of partial angular spectrum areas.

13. The apparatus of claim 8, wherein the mesh includes a triangular mesh.
